(19) United States
(12) Patent Application Publication
(10) Pub. No.: US 2008/0224339 A1
(43) Pub. Date: Sep. 18, 2008

(54) Prismatic Films for Optical Applications

(76) Inventors: Jann Schmidt, Weiterstadt (DE); Alexander Laschitsch, Frankfurt (DE); Christian Roth, Lautertal (DE); Christoph Krohmer, Motzingen (DE); Helmut Haring, Reinheim (DE); Detlef Birth, Dieburg (DE)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/091,174

(22) PCT Filed: Oct. 2, 2006
(86) PCT No.: PCT/EP06/66963

§ 371 Date: Apr. 23, 2008

(30) Foreign Application Priority Data
Dec. 16, 2005 (DE) 10 2005 060 731.4

(51) Int. Cl. B29C 59/04; B29C 47/04

(52) U.S. Cl. 264/1.7; 264/173.17

(57) ABSTRACT

The invention relates to coextruded foils with prism structure, to a process for production of coextruded foils with prism structure and to uses.

The invention relates to a coextruded plastics foil with prism structure, to a process for production of coextruded plastics foils with prism structure and to their uses.

For various applications, industry has developed processes for structuring of plastic surfaces where the plastic is suitable for this purpose. By way of example, in the case of thermoplastics structuring of the surface is preferably achieved via the action of an embossing device on the surface which has been brought to the appropriate temperature. (Becker-Braun, Kunststoff-Handbuch [Plastics handbook], Vol. 1, 543-544, Hanser-Verlag 1990; K. Stockhert, Veredeln von Kunststoffoberflāchen [Finishing of plastics surfaces], Hanser 1975). Commercially available products are, inter alia, plastics panel material based on PMMA with characteristically structured surfaces. These are produced, inter alia, via extrusion with simultaneous embossment in a three-roll polishing stack (calender). One roll (embossing roll) here has been provided with the negative of the desired sheet structure. In the case of structured sheets the objective is maximum quality of reproduction of the roll structure. This objective is achieved via setting of minimum melt viscosity and maximum roll temperature. Furthermore—as apparent from practice—the pressure maximum prior to the narrowest point in the nip (i.e. the gap between smooth roll and structured roll) should be high in order to permit transfer of maximum embossing forces. Result of the three conditions mentioned is inevitable compromises when structured panels are extruded industrially.

Production of plastics sheets with structured surfaces according to the process of the prior art encounters its limits particularly where there are particularly stringent requirements in relation to fineness and precision of the structure.

There is limited opportunity for appropriate adjustment of the parameters described: the roll temperature cannot be increased as desired, since most plastics melts stick to hot metals. This tendency to stick leads to difficulties in release from the embossing roll, starting at a certain roll temperature. The melt viscosity of the plastic cannot be selected to be as low as desired, for example via setting high melt temperatures, since otherwise the embossing force in the nip becomes too small.

Precision of reproduction of sheets produced by this process and with these restrictions is not good enough for certain applications, i.e. fine structures are not correctly shaped or are rounded-off. It was therefore an object to provide a process which can produce structured surfaces and which meets the requirements mentioned, such as high precision of reproduction of the embossing roll with a very fine surface structure. Another problem is production of thin foils with structured surfaces. DE 4407468 limits sheet thicknesses to from 0.5 to 25 mm. The thickness of the relatively low-viscosity layer applied is limited to from 0.2 to 5 mm. The resultant products are solid panels whose thicknesses are from 0.7 to 30 mm. It is very difficult to transfer the sheet-production technique to thin foils.

Another object was to provide thin foils with a structured surface.

U.S. Pat. No. 5,175,030 describes a process for production of foils with prism structure. A complicated batchwise process applies a resin to a finished foil and uses a master for embossing and uses UV radiation to cure the composite. The master is then separated from the microstructured film. Disadvantages are not only the high production costs, inter alia from the batchwise production method, but also the restricted foil dimension. The maximum dimension of the master is about 1200×1200 mm.

Another object was to provide a cost-effective, continuous process.

The object has been achieved via a continuous process for production of coextruded plastics foils with prism structure, characterized in that the extrusion process coextrudes a base foil whose thickness is from 0.10 to 0.35 mm and a low-viscosity layer and then the foil composite is provided with structuring by means of a heatable polishing roll stack comprising a roll with a structuring surface.

An extrusion system equipped with 2 extruders and with a polishing roll stack, comprising a roll with structured surface (embossing roll), is used to produce a coextruded plastics foil where a low-viscosity layer is applied to a high-viscosity base foil. The coextruded plastics foil is then structured via the embossing roll in the polishing roll stack. The use of a high-viscosity base foil ensures that the necessary embossing force is introduced. Both base foil and coextrusion layer are preferably thermoplastics.

Thermoplastics that can be used are polyacrylates, in particular PMMA, polycarbonate, polyolefins, LDPE, HDPE, PP, polyethylene terephthalate, PVC, polystyrene, polyamide. The low-viscosity coextrusion layer can advantageously be composed of plastics grades identical with those of the base foil, however, it can also be composed of a plastic sufficiently compatible therewith. (cf. J. E. Johnson, Kunststoffberater 10, 538-541 (1976)). A general rule that can be stated is that the melt viscosity of the coextrusion material should correspond to that of an injection-moulding composition for high precision of reproduction. It is particularly preferable to use polycarbonate, since the refractive index of 1.58 has good suitability for optical applications. By way of example, efficient deflection of light is ensured by using polycarbonate.

The coextruded layer is preferably composed of a low-viscosity material. Flow improvers can also be added to the material. Suitable flow improvers are low-molecular-weight compounds, an example being low-molecular-weight polymethyl methacrylate.

The MVR (melt volume flow rate) ratio between high-viscosity base foil and low-viscosity coextrusion layer is ideally from 1:20 to 1:8, preferably 1:10.

The thickness of the low-viscosity coextrusion layer depends on the function. The embossment of a structure demands that process parameters are precisely and appropriately adjusted. There are limited possibilities for appropriate adjustment: the roll temperature cannot be increased as desired, since most plastics melts stick to hot metals. This tendency to stick leads to difficulties in release from the embossing roll, starting at a certain roll temperature. The melt viscosity of the plastic cannot be selected to be as low as desired, for example via setting high melt temperatures, since otherwise the embossing force in the nip becomes too small.

If the coextrusion layer is adjusted to higher viscosity, the forces applied via the pressure from the paired rolls are not sufficient to achieve an acceptable embossment.

The layer thickness of the coextrusion layer therefore exerts a particular influence. The layer thickness should comprise at least one quarter of the structure height of the embossing roll for good reproduction of the structure.

Surprisingly, it has been found that application of a very thick coextrusion layer composed of low-viscosity plastic leads to embossment of a uniform prism structure even if, contrary to the statement in DE4407468, the maximum depth of the structure of the embossing roll is exceeded by the low-viscosity coextrusion layer.

If the process parameters are appropriately and ideally adapted it is possible to omit any use of release agents. If, despite this, the use of release agents is required in the coextrusion layer, the person skilled in the art can make use of the materials known from the prior art (H. F. Mark et al., Encyclopedia of Polymer Science & Engineering, Index Volume pp. 307-324, J. Wiley 1990; Ullmann's Encyclopedia of Industrial Chemistry, 5th Ed. Vol. A20, pp. 479-483, VCH 1992; R. Gaechter, H. Müller Kunststoffadditive [Plastics additives], 3rd Edn. Carl Hanser Verlag 1989).

The content of the release agents used with the coextrusion layer is preferably in the range from 0 to 0.34% by weight, based on the weight of coextrudate. Particular mention may be made of higher alcohols.

Use of a release agent in the coextrusion composition reduces the tendency of the melt to stick to hot metal. The embossing roll temperature can therefore be increased considerably during the embossing process. Up to 70° C. above the glass transition point Tg of the coextrusion composition may be mentioned as a guide. (The glass transition temperatures Tg are known or can be computed (cf. Brandrup-Immergut, Polymer Handbook, Chapter V, J. Wiley, Vieweg-Esser, Kunststoff-Handbuch [Plastics handbook], Vol. IX, 333-340, Carl Hanser 1975).

A possible method for the inventive process is as follows: the extrusion system in essence is composed of a main extruder, of a coextruder and of a coextrusion tool.

The maximum width of the extruded foils is determined via the coextrusion tool. The width of the extruded foils is generally from 400 to 2000 mm. Their thickness is likewise limited via the conditions of the coextrusion process; the thickness of the base foil is generally from 0.10 to 0.35 mm, and the main determining factor here for the layer formed from the low-viscosity material is the function intended with the structuring. However, its layer thickness is generally from 0.006 to 0.075 mm. The structure depth of the embossing roll is ideally from 0.025 to 0.070 mm.

The base moulding composition, brought to a suitable temperature via the main extruder, and the low-viscosity moulding composition, brought to a suitable temperature in the coextruder, are combined in the coextrusion tool. An approximate guide here for the resultant die temperatures for the base moulding composition is as follows:

| | Processing temperature |
|---|---|
| Base moulding composition | (° C.) |
| Polymethyl methacrylate | 230-290 |
| Polystyrene | 190-230 |
| Polycarbonate | 250-300 |

The coextrudate emerging from the coextrusion tool is passed over the polishing roll stack, where one roll, as embossing roll, has been designed in such a way that its surface represents the negative of the desired structured foil surface. Between the pressure-application roll and the embossing roll there is the nip. The pressure maximum here is intended to be high prior to the narrowest point, to permit transfer of maximum embossing force. The polishing roll stack corresponds in other respects to the prior art. The extruded foils with structured surface are transported over support rollers. They can then be cut and/or wound to the desired length. The profile then represents an exact reproduction of the embossing roll surface.

It has been found that it is possible for the first time to provide coextruded plastics foils of any desired length with prism structure, the thickness of the base foil thereof being from 0.10 to 0.35 mm.

The MVR ratio of base foil to the coextruded layer in the coextruded plastics foils with prism structure is from 1:20 to 1:8, preferably 1:10.

The thickness of the coextruded layer can be at least half of the structure height. Contrary to DE 4407468, the thickness of the coextruded layer can be greater than the structured depth of the embossing roll.

An application sector for the foils produced according to the invention is provided by optical materials. Since optical applications require a material of high quality, this process is preferably carried out under cleanroom conditions. For the application, which is of particular interest, as foil for back-lighting of displays, operation take place in class 100 cleanroom conditions, since dust in the ambient air would lead to unacceptable soiling of the foil.

The examples given below are given to provide better illustration of the present invention, but should not restrict the invention to the features disclosed herein.

### EXAMPLES

### Example 1

Polycarbonate whose MVR value is 6 is coextruded with a low-viscosity polycarbonate whose MVR value is 66 in a coextrusion system.

The width of the base foil is 1800 mm and its thickness is 150 μm, and the thickness of the coextruded layer is 25 μm.

The coextrudate is passed over a heatable polishing roll stack, in this case a three-roll polishing roll stack, which has an embossing roll with prism structure. The structured depth of the embossing roll is 50 μm. The embossing roll is heated to about 200° C. The coextruded foil is passed over the embossing roll with a velocity of 20 m/min.

The product is a coextruded plastics foil composed of polycarbonate with very good replication of the prism structure, the products being suitable for optical applications, for example for back-lighting of displays.

### Example 2

Polycarbonate whose MVR value is 6 is coextruded with a low-viscosity polycarbonate whose MVR value is 66 in a coextrusion system.

The width of the base foil is 400 mm and its thickness is 500 μm, and the thickness of the coextruded layer is 70 μm.

The coextrudate is passed over a heatable polishing roll stack, in this case a three-roll polishing roll stack, which has an embossing roll with prism structure. The structured depth of the embossing roll is 50 μm. The embossing roll is heated to about 200° C. The coextruded foil is passed over the embossing roll with a velocity of 2 m/min.

The product is a coextruded plastics foil composed of polycarbonate with very good replication of the prism structure, the products being suitable for optical applications, for example for back-lighting of displays.

### Example 3

Polycarbonate whose MVR value is 3 is coextruded with a low-viscosity polycarbonate whose MVR value is 60 in a coextrusion system.

The width of the base foil is 400 mm and its thickness is 500 μm, and the thickness of the coextruded layer is 70 μm. The coextrudate is passed over a heatable three-roll polishing roll stack, which has an embossing roll with prism structure. The structured depth of the embossing roll is 50 μm.

The embossing roll is heated to about 200° C. The coextruded foil is passed over the embossing roll with a velocity of 2 m/min.

The product is a coextruded plastics foil composed of polycarbonate with very good replication of the prism structure, the products being suitable for optical applications, for example for back-lighting of displays.

### Example 4

Polymethyl methacrylate whose MVR value is 1.2 is coextruded with a low-viscosity polymethyl methacrylate whose MVR value is 12 in a coextrusion system.

The width of the base foil is 400 mm and its thickness is 800 μm, and the thickness of the coextruded layer is 25 μm. The coextrudate is passed over a heatable three-roll polishing roll stack, which has an embossing roll with prism structure. The structured depth of the embossing roll is 100 μm.

The embossing roll is heated to about 180° C. The coextruded foil is passed over the embossing roll with a velocity of 2 m/min.

The product is a coextruded plastics foil composed of polymethyl methacrylate with very good replication of the prism structure.

1. Continuous process for production of coextruded plastics foils with prism structure, characterized in that the extrusion process coextrudes a base foil whose thickness is from 0.10 to 0.35 mm and a low-viscosity layer and then the foil composite is provided with structuring by means of a heatable polishing roll stack comprising a roll with a structuring surface.

2. Continuous process for production of coextruded plastics foils according to claim 1, characterized in that the extrusion process coextrudes a base foil whose thickness is from 0.10 to 0.35 mm and a low-viscosity layer whose thickness comprises at least one quarter of the structure height.

3. Continuous process for production of coextruded plastics foils according to claim 2, characterized in that the extrusion process coextrudes a base foil and a low-viscosity layer whose thickness is greater than the structure height.

4. Continuous process for production of coextruded plastics foils according to claim 1, characterized in that the MVR ratio of base foil and low-viscosity layer is from 1:8 to 1:20.

5. Continuous process for production of coextruded plastics foils according to claim 1, characterized in that the temperature of the embossing roll is above the glass transition temperature of the coextrusion composition by up to 70° C.

6. Continuous process for production of coextruded plastics foils according to claim 1, characterized in that the coextrusion composition also comprises release agent.

7. Coextruded plastics foil with prism structure, characterized in that the thickness of the base foil is from 0.10 to 0.35 mm.

8. Coextruded plastics foil with prism structure, characterized in that the MVR ratio of base foil to a coextruded layer is from 1:20 to 1:8.

9. Coextruded plastics foil according to claim 7, characterized in that the MVR ratio of base foil to coextruded layer is 1:10.

10. Coextruded plastics foil according to claim 7, characterized in that the thickness of the coextruded layer comprises at least one quarter of the structure height.

11. Coextruded plastics foil according to claim 7, characterized in that the thickness of the coextruded layer is greater than the structure depth.

12. Use of the coextruded plastics foils produced by the process according to claim 1 for optical applications.

13. Use of the coextruded plastics foils produced by the process according to claim 1 for back-lighting of displays.
